(19) United States
(12) Patent Application Publication
(10) Pub. No.: US 2003/0067491 A1
(43) Pub. Date: Apr. 10, 2003

(54) Column node (CN)

(76) Inventor: Charles W. Cadwallader, Philadelphia, PA (US)

Correspondence Address: Charles W. Cadwallader, 2036 Spruce Street, Philadelphia, PA, 19103, US

(21) Appl. No.: 10/223,115

(22) Filed: Aug. 19, 2002

Related U.S. Application Data
(60) Provisional application No. 60/322,600, filed on Sep. 17, 2001.

(51) Int. Cl. G09G 5/00

(52) U.S. Cl. 345/779

(57) ABSTRACT

Time Scaled Critical Path Method (TSCPM) and Bar/Ghantt Chart (Bar Chart) Precedence Network Diagrams have a horizontal frame that contains a calendar Time Scale of units selected by the project planner and horizontal rows beneath that Time Scale to contain Tasks/Activities (Tasks). Tasks are placed in those horizontal rows below the Time Scale at the time selected by the project planner and in the rows indicating their relationship to other tasks in the project. Tasks have a vertical depth that allows for the task identification to be written on them.

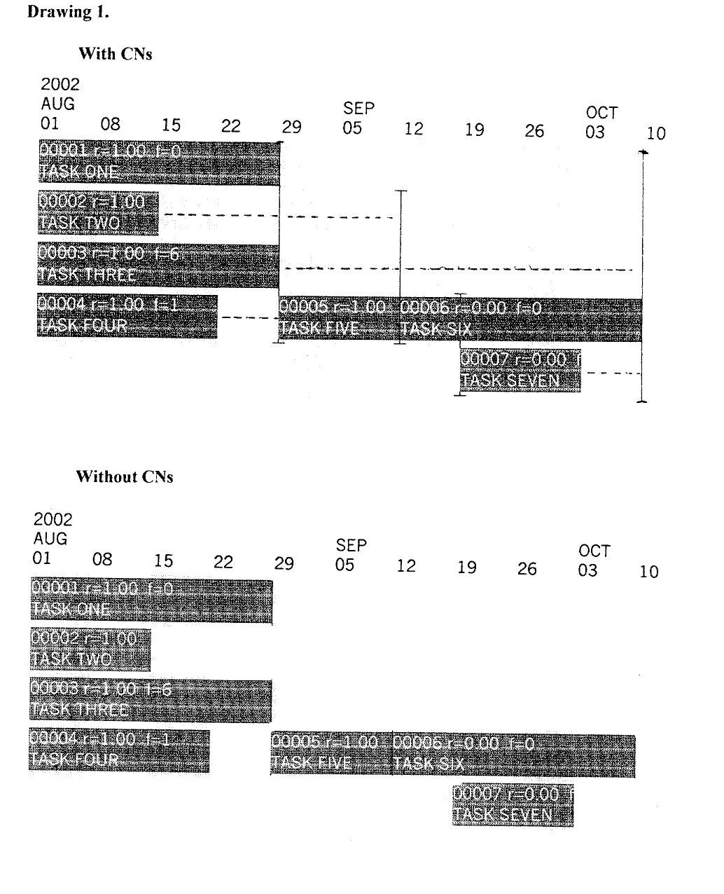

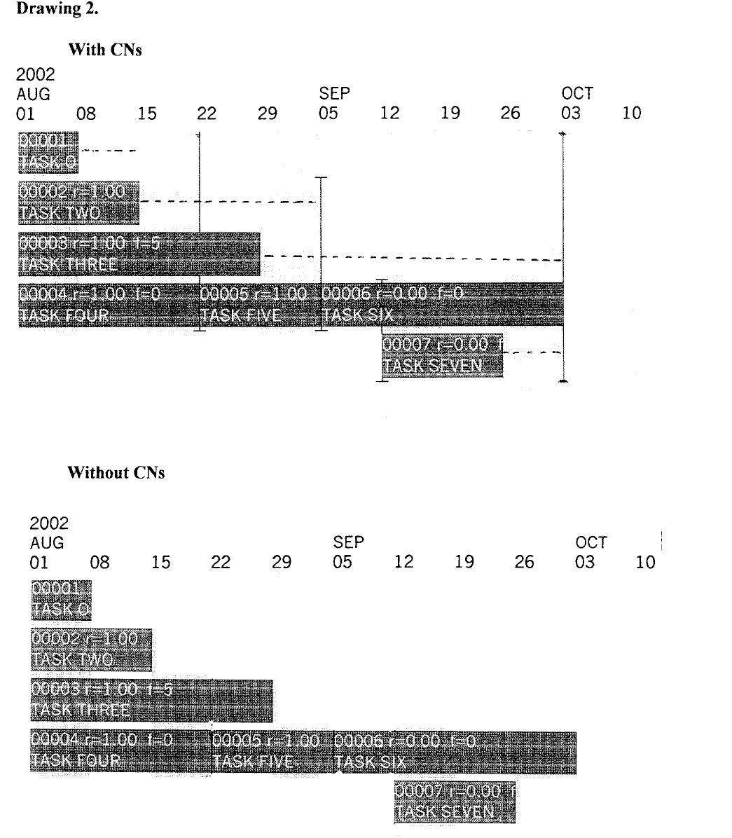

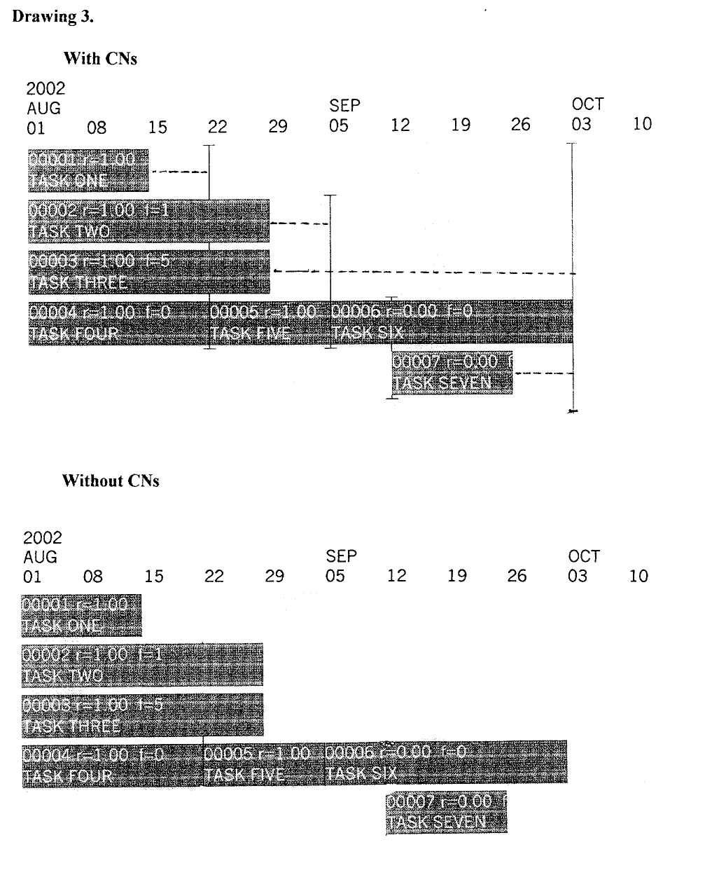

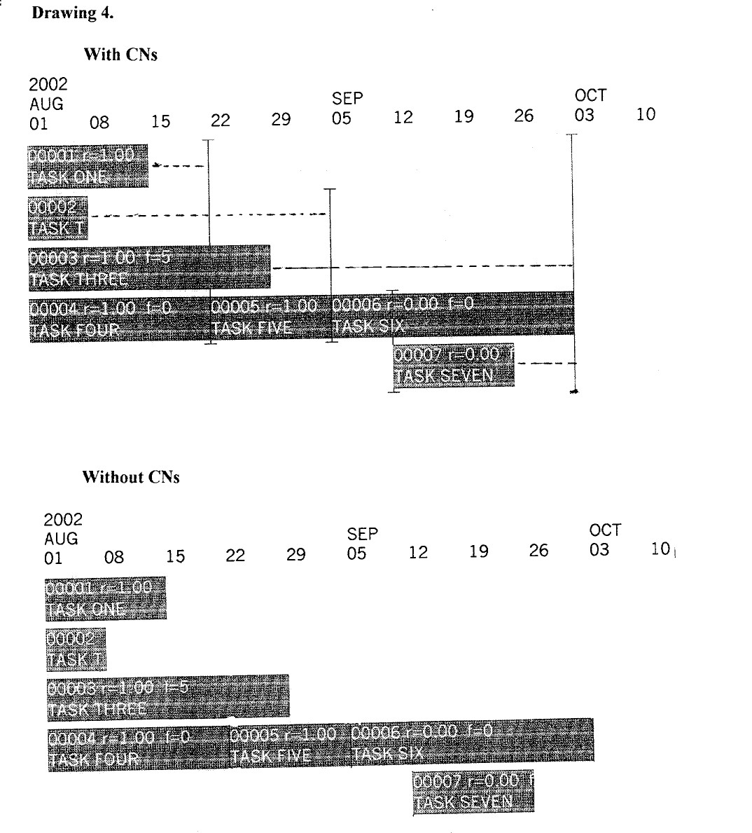

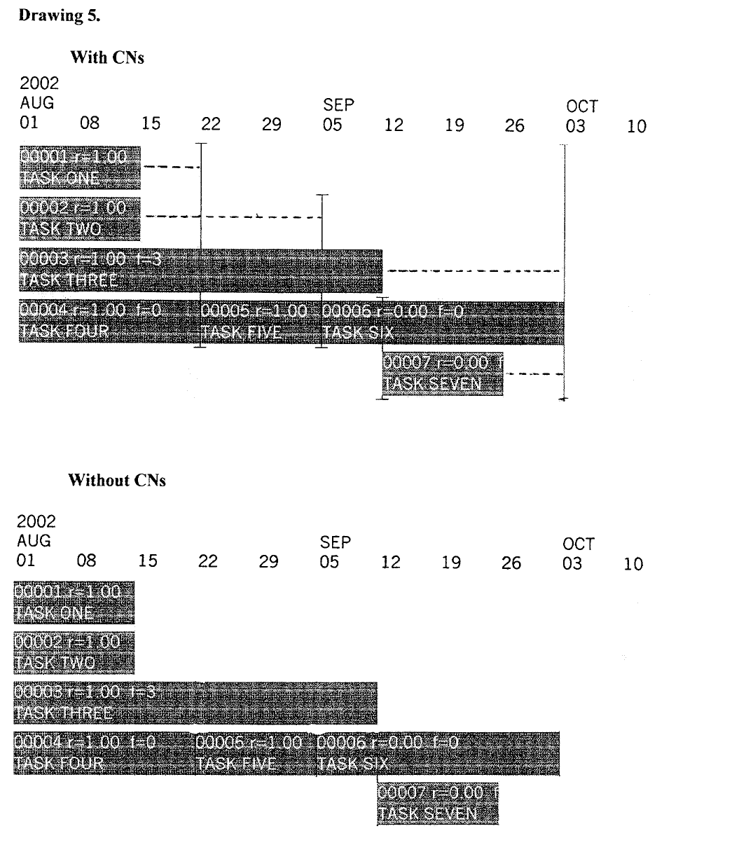

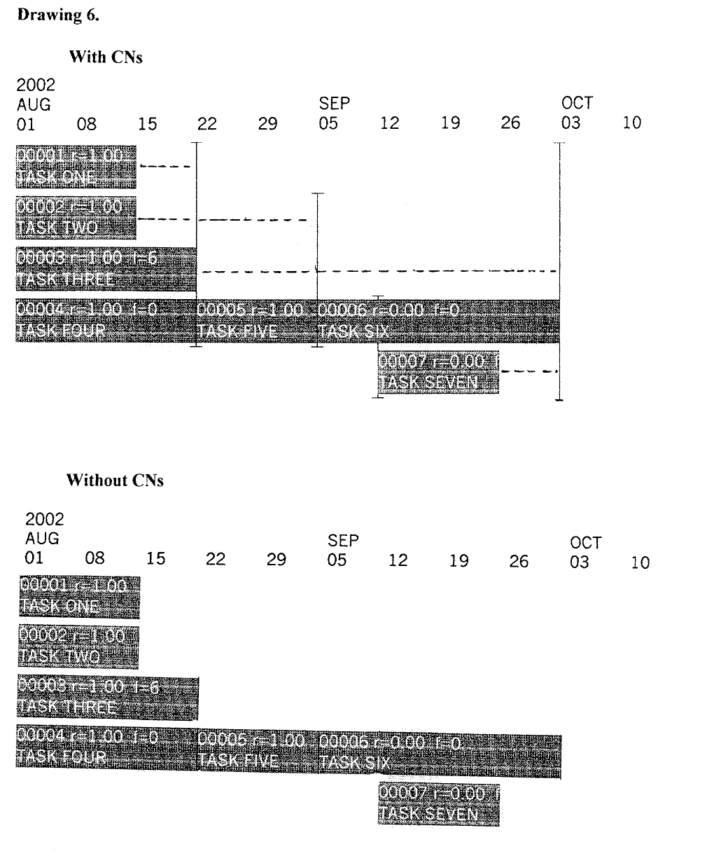

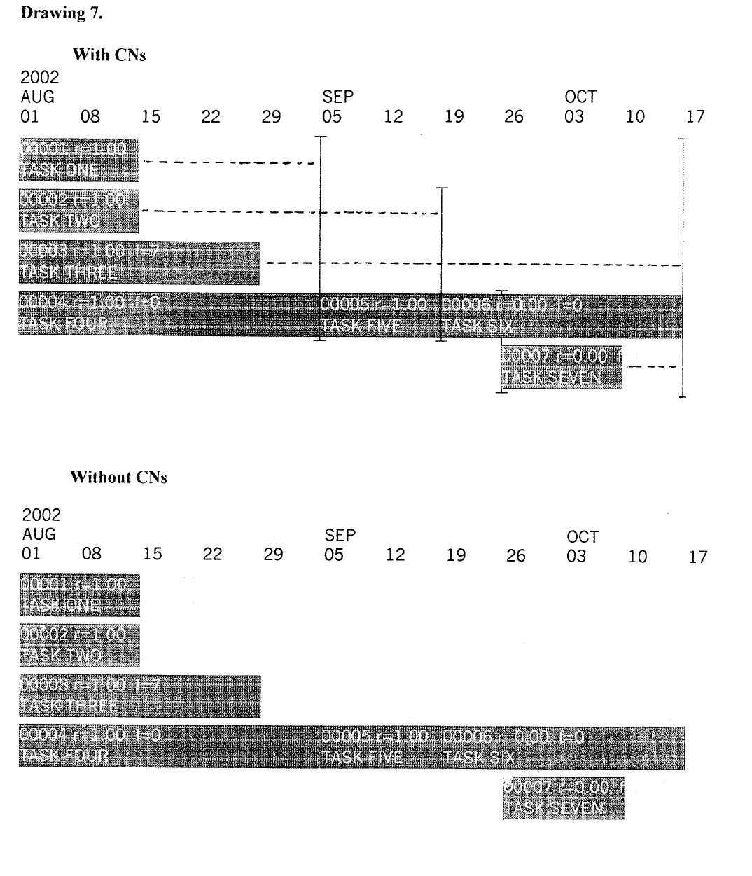

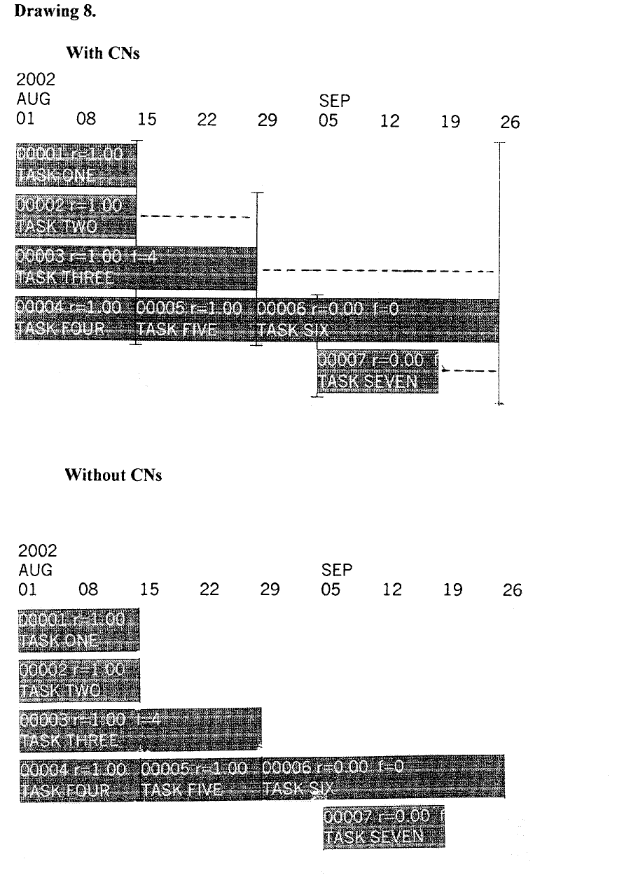

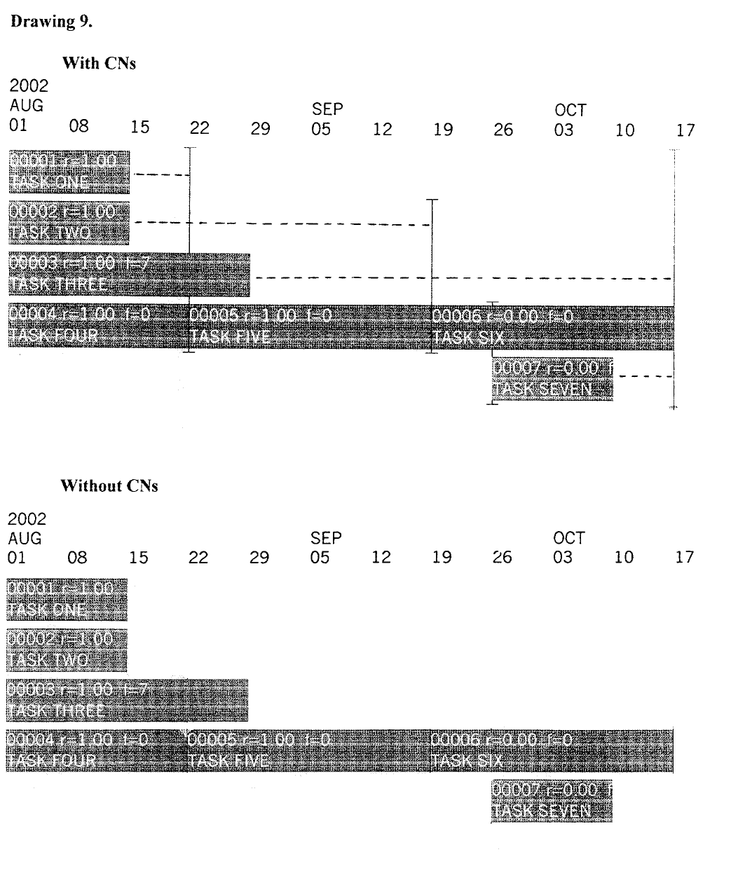

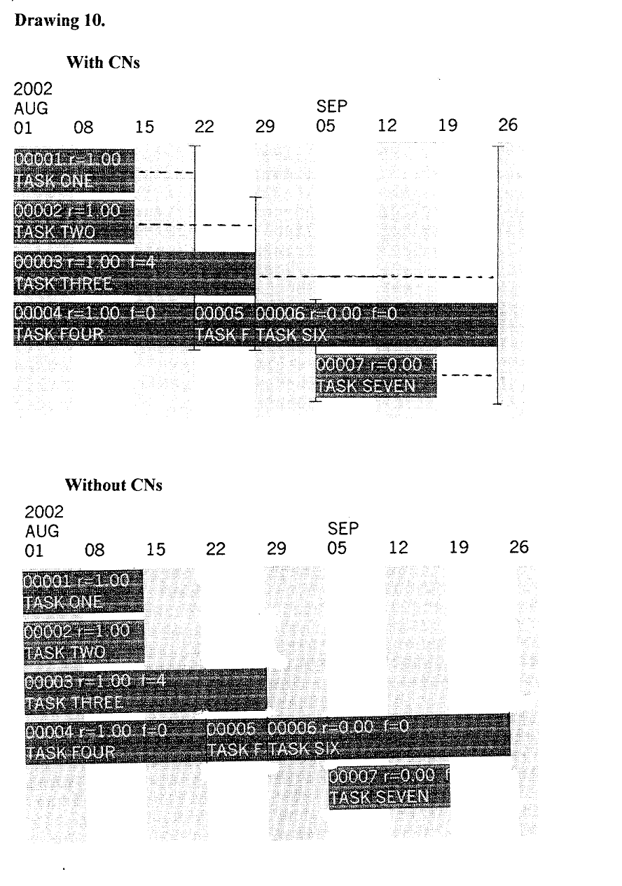

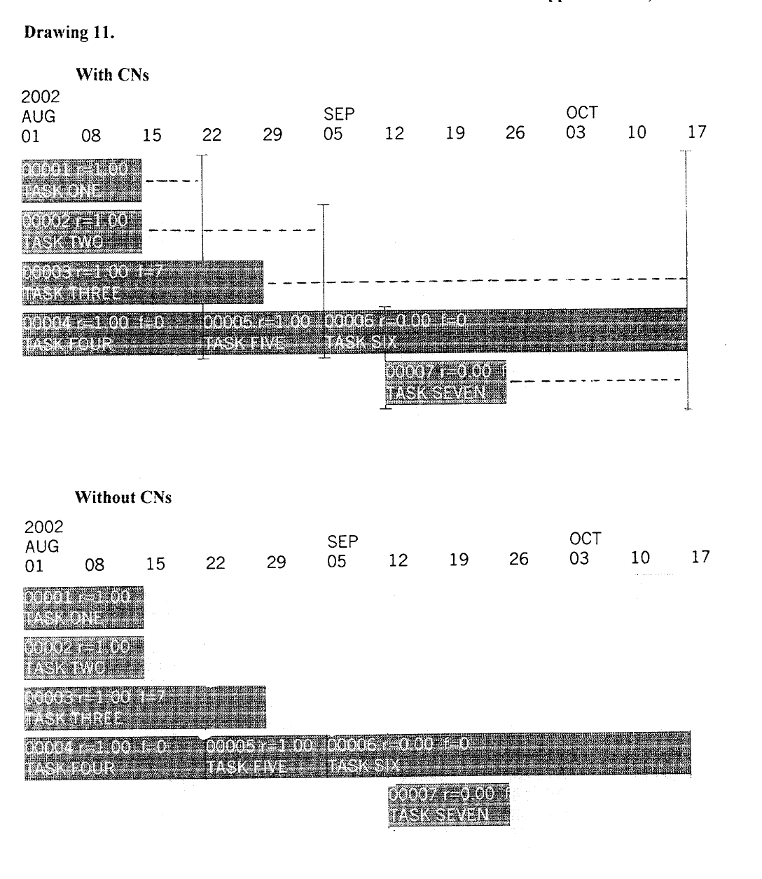

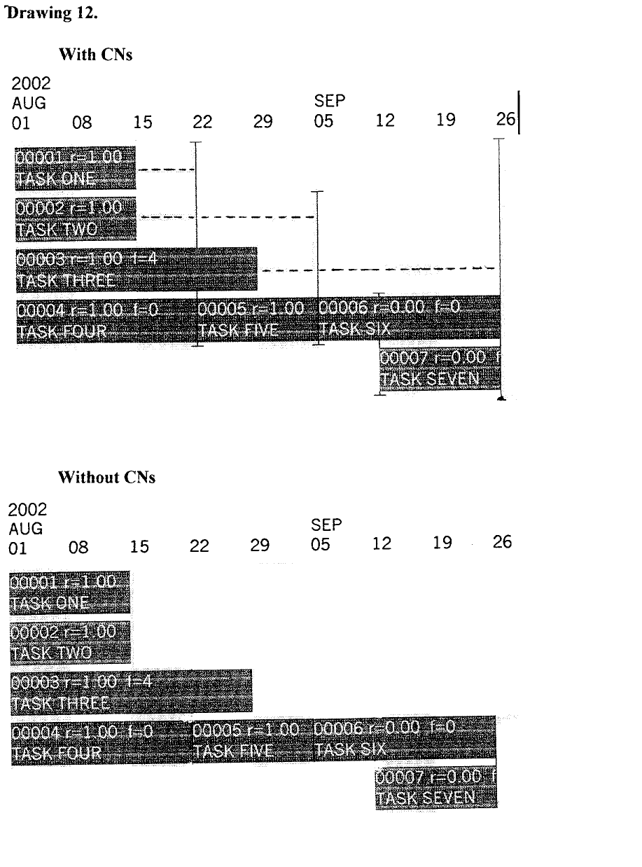

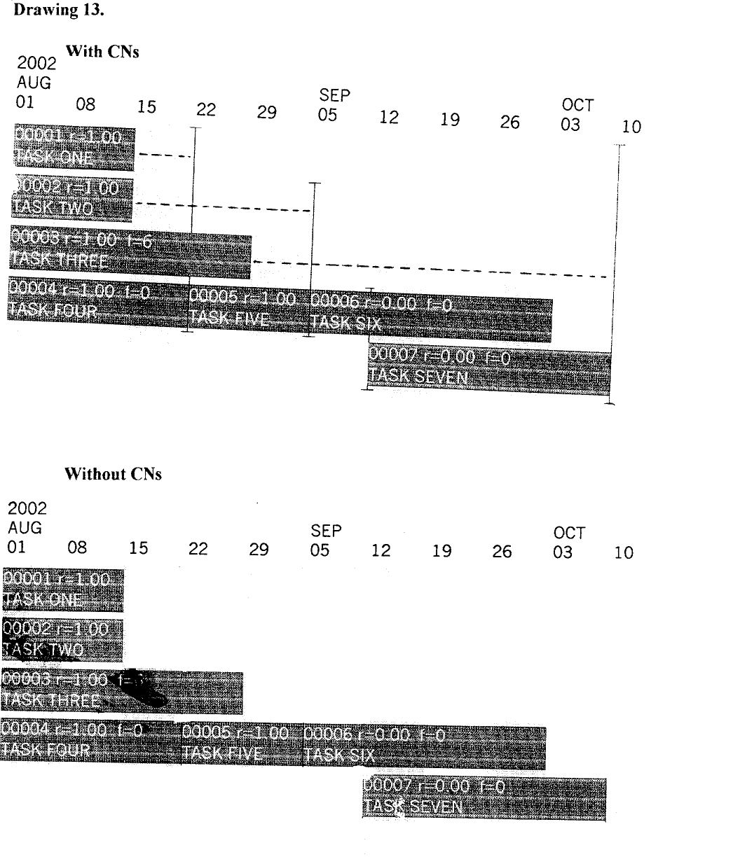

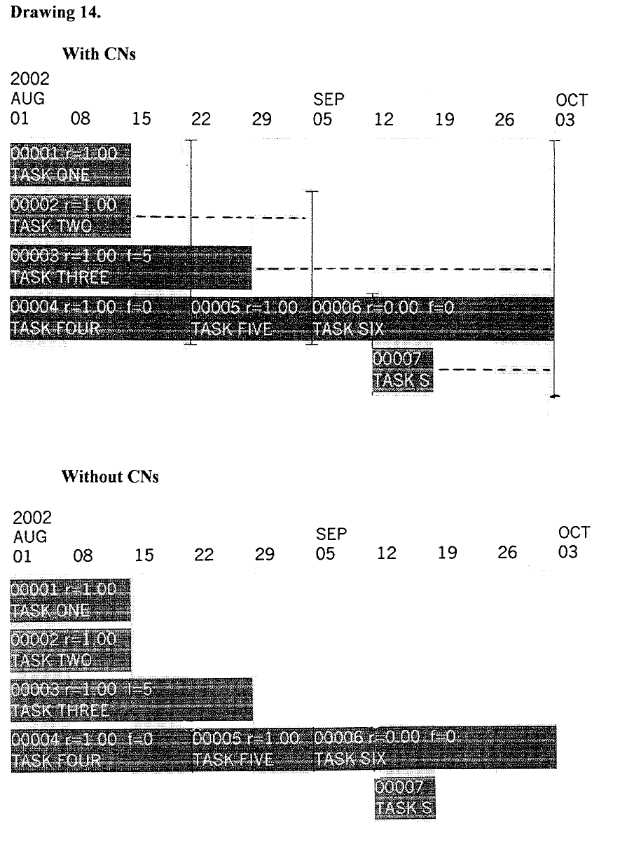

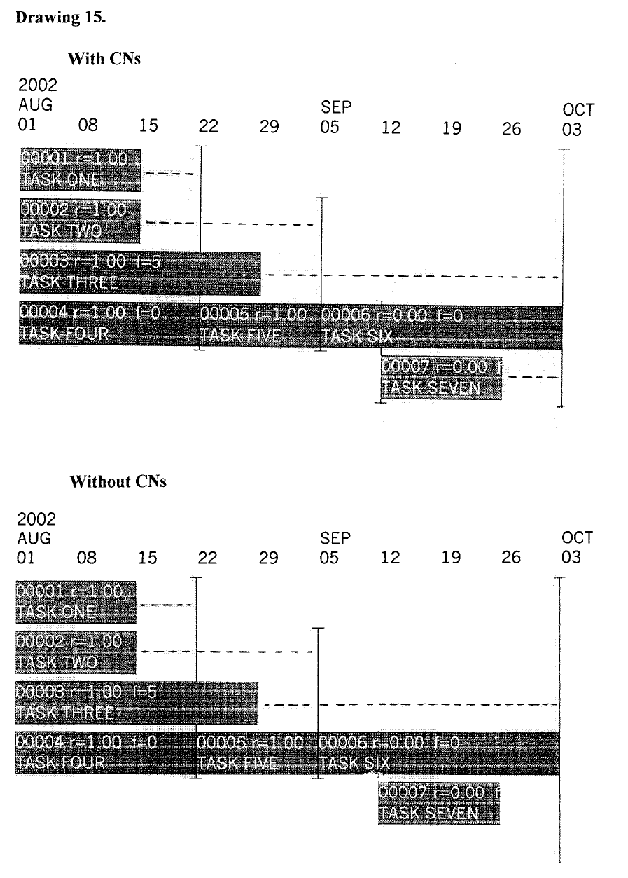

Nodes in computer generated TSCPM and Bar Chart precedence network diagram project plans are invisible points in time that denote completion of a scheduled task or tasks, or designated portions thereof, plus their float, which impact temporally on a scheduled primary dependant task or tasks. Nodes also indicate the scheduled time of completion of the final task or tasks of a project, denoting project completion.

Column Nodes (CNs) arc graphic illustrations of the invisible Nodes in TSCPM and Bar Chart precedence network diagrams. CNs In TSCPMs and Bar Charts are vertical lines with caps on the top and bases on the bottom. CNs, as the invisible Nodes they are a translation of, denote the time in a plan where completion of a scheduled task or tasks, or designated portions thereof, plus their float, impact temporally on a scheduled primary dependant task or tasks. CNs also indicate the scheduled time of completion of the final task or tasks of a project, denoting project completion.

### REFERENCES CITED

U.S. Patent Documents [Referenced By]

| | | | |
|---|---|---|---|
| 2234248 | March, 1941 | Hanford | 434/108 |
| 2649790 | August, 1953 | Johnson | 434/430 |
| 2732822 | June, 1956 | Cassady et. al. | 116/324 |
| 2884713 | May, 1959 | Campbell | 434/108 |
| 3124885 | March, 1964 | Mendell | 35/24 |
| 3380177 | April, 1968 | Wagner | 35/24 |
| 3403458 | October, 1968 | Mendall | 35/24 |
| 3488863 | January, 1970 | Mendell | 35/24 |
| 3522666 | August, 1970 | Sarthou | 35/24 |
| 3735109 | May, 1973 | Berthelemy et. al. | 235/185 |
| 4019027 | April, 1977 | Kelley | 235/89 |
| 4821220 | April, 1989 | Duisberg | 703/2 |
| 4970664 | November, 1990 | Kaiser et al. | 364/52 |
| 5101340 | March, 1992 | Nonaka et al. | 395/650 |
| 5197001 | March, 1993 | Mukherjee | 364/403 |
| 5381332 | January, 1995 | Wood | 364/401 |
| 5563994 | October, 1996 | Harman, et al. | 345/440 |

### OTHER REFERENCES

“The Gantt Chart, a Working Tool of Management” By Wallace Clark, 1952

“Project Management With CPM and PERT”, By Joseph J. Moder, 1964

“Network—Based Management Systems (CPM/PERT)”, By Russell D. Archibald, 1967

“Critical Path Scheduling: Management control through CPM and PERT”, By Ronald Press Company, 1967

“Fundamentals of Project Management”, By James P. Lewis, AMACOM, 1977, New York.

“Getting Started in Project Management”, By Paula Martin and Karen Tate, John Wiley and Sons, Inc., New York.

“Managing Implementation of Development Projects” By John Didier, Planning and Scheduling with the Critical Path Method (CPM), May 1998, pp 46-51.

“Breakthrough Technology Project Management”, By Bennet P. Lientz and Kathryn P. Rea, Academic Press 2000.

“Project Management for Dummies”, By Stanley E. Portny, Hungry Minds, Inc., 2000, New York.

### BACKGROUND OF THE INVENTION

Over time, man has devised philosophies to better manage projects, such as Work Breakdown Structure, Span of Control, and Management By Objectives and has attempted to devise project management systems that utilize these management philosophies. Man has also devised systems for planning and controlling projects: Task List, Bar Chart, PERT (Program Evaluation and Review Technique), and CPM (Critical Path Method). All of these project control systems were later programmed for the computer to make rapid computations and develop presentations. None, however, presented an adequate picture of the project. Among the project management system presentations PERT has an event oriented presentation and it's Nodes express variable points in time that are not easily represented on Precedence Network Diagrams, CPM is Task oriented and is represented on charts very well, but it does not indicate time or Nodes well, and Time Scaled CPM is an especially good chart, but it still does not represent Nodes well. By emphasizing Nodes with CNs in TSCPM and Bar Chart presentations we have achieved the best presentation of projects on charts to date. Good presentation is all important to management, especially Top Management, which has little time to review projects.

In project management consulting it was noted that many in corporate management, especially top management, could not properly read project management plan displays. Few wanted to admit to this condition. This put the power of project development and status in the Project Manager's position and left top management uninformed. TSCPM and Bar Charts helped in presenting project plans, but they lacked the import function of properly displaying task relationships and dependancies.

To cure this condition the idea came to mind of a Node translated and presented as a column. A graphic which could be easily viewed and its function easily discerned. That idea worked on both hand drawn and computer generated project plans. Hand drawn plans require so much redrawing following any small change in planning that it becomes impractical. Any change in the early stages of a plan would require redrawing of the whole plan. With the computer's rapid calculation, that rescheduling a plan at any point is no longer a problem. This claim, therefore, is an improved project plan presentation dependant upon computer generated TSCPM and computer generated Bar Chart project Precedence Network Diagram planning systems.

### SUMMARY

This claim is for a specifically sized and placed graphic column, called a CN, to perform the same function as a Node in TSCPM and Bar Charts. The CN translates the invisible Node into an easy to read column performing the same and additional functions as Nodes. That translation of the Node to an easy to read Nodal planning function enhances the understanding of task dependancies and relationships and time of project completion to the viewer.

CNs have a defined horizontal position and vertical extension in TSCPM and Bar Chart type Precedence Network Diagrams which clearly demonstrate the relationship among tasks and the completion of a project.

TSCPM and Bar Chart CN display graphics can be programmed to vary in appearance. The width and color of CNs can vary according to the desire of the system designer, but CNs will always be a straight line, or column, drawn vertically through the horizontal rows of a project plan, from the earliest primary dependant tasks at their leading edge and extended vertically through the project plan rows of all tasks they are primarily dependant upon plus the rows of other tasks sharing the same primary dependancy.

### BRIEF DESCRIPTION OF THE DRAWINGS

The drawings are of an identical, sample plan illustrated without CNs (above), and with CNs, (below) on the same page, to illustrate CNs and show the comparison of plans without and with CNs, thereby the importance of CNs.

Dashed horizontal lines designating float are available for use and used in the illustrations with CNs.

The figures also contain notes as to the difference between plans without CNs and those same plans with CNs to bring to the viewers attention the advantages of CNs.

### DESCRIPTION

Time Scaled Critical Path Method (TSCPM) and Bar/Ghantt Chart (Bar Chart) Precedence Network Diagrams have a horizontal frame that contains a calendar Time Scale of time units selected by the project planner and horizontal, parallel rows beneath that Time Scale to contain project Tasks/Activities (Tasks). Tasks are placed in those horizontal rows below the Time Scale at the time selected by the project planner and in the rows indicating their relationship to other tasks in the project. Rows and Tasks have a vertical depth which allows for the tasks identification to be written on them.

Nodes in computer generated TSCPM and Bar Chart Precedence Network Diagrams project plans are invisible points in time that denote completion of a scheduled task or tasks, or designated portions thereof, plus their float, which impact temporally on a scheduled primary dependant task or tasks. Nodes also indicate the scheduled time of completion of the final task or tasks of a project (project completion).

Column Nodes (CNs) are graphic illustrations of the invisible Nodes in Time Scaled Critical Path Method (TSCPM) and Bar/Ghantt Charts (Bar Chart) Precedence Network Diagrams. CNs In TSCPMs and Bar Charts are vertical lines with caps on the top and bases on the bottom. CNs denote the time in a plan where completion of a scheduled task or tasks, or designated portions thereof, plus their float impact temporally on a scheduled primary dependant task or tasks. CNs also indicate the scheduled time of completion of the final task or tasks of project (project completion).

Appearance:

All CNs are the width and color desired by a TSCPM or Bar Chart system designer. All CNs have caps at the top and bases at the bottom indicating the vertical terminations at the top and bottom of any CN. The CN caps and bases are the width of the CN they are associated with and are drawn within the CN at it's farthest vertical extensions. They extend beyond the CN leading edge and trailing edge so as to be noticeable, the extent being at the system designer's discretion. CNs will always be a straight, vertical lines (Columns) that extend across all of the horizontal project plan rows in which it's Primary Task, Primary Group, Primary Dependant Task, or Primary Dependant Group reside.

Placement:

CNs associated with project tasks (Task CNs) and CNs associated with completion of a project's final tasks (Project CNs) have specialized placement and functions in TSCPM and Bar Charts and are described as follows:

a. Task CNs:

Any task that has a direct task dependancy is a Primary Task. Any task that is directly dependant on a Primary Task is a Primary Dependant Task.

Any multiple Primary Tasks, all of which have exactly the same Primary Dependant Task or Tasks, is a Primary Group.

Any multiple Primary Dependant Tasks, all of which have exactly the same Primary Task or Primary Group, is a Primary Dependant Group.

Task CNs extend vertically from the horizontal point in calendar time of the latest scheduled completion time of the Primary Task or Primary Group.

CNs are continuous, straight, vertical lines (Columns) that extend across all of the horizontal project plan rows in which it's Primary Task, Primary Group, Primary Dependant Task, or Primary Dependant Group reside.

The CN indicates that it's Primary Task or Primary Group can not be scheduled to complete at a calendar time subsequent to that CN and that it's Primary Dependant Task or Primary Dependant Group can not be scheduled to start prior to the calendar time of that CN.

Task CNs crossing vertically through horizontal rows occupied by tasks in the same time period, but which do not have any related, primary dependancy, pass under that unrelated task and are therefore invisible to the viewer in that row of the plan.

Where Task CNs cross vertically through horizontal rows occupied by the float of tasks in the same time period, but which does not have any related, primary dependancy, the dashed float symbol extends horizontally through the CN and continues to its own related CN or other restriction.

Some Primary Dependant Tasks are dependant on the completion of only a portion of a Primary Task. In such cases the CN starts from a point representing the completion of a designated portion (in time units) of the Primary Task and extends vertically across the horizontal rows of the plan to include the Primary Task row and the rows of it's Primary Dependant Tasks.

1. Having thus disclosed my invention I claim that computer generated Time Scaled Critical Path Method or Bar Chart precedence network diagrams with Column Nodes provide an improved understanding of a project plan, wherein the improvement comprises:
a. An improved graphic representation of a project for a viewer to better determine the relationships among scheduled tasks in a project plan.
b. An improved graphic representation of a project for a viewer to better determine the available float of any scheduled task in a project plan.
c. An improved graphic representation of a project for a viewer to better determine the scheduled chain of project tasks that determine the duration of the scheduled project to completion (the critical path). A project critical path is that chain of tasks of no, or least, primary float and where any change in a task duration will alter the project completion time.
d. An improved graphic representation of a project for a viewer to better determine quick and accurate responses to external influences that cause project changes.

2. Having thus disclosed my invention I claim that computer generated Time Scaled Critical Path Method or Bar Chart precedence network diagrams with Column Nodes provide improve management communications, wherein the improvement comprises:
a. An improved graphic representation of a project which better illustrates TSCPM and Bar Chart project plans, making them easier to develop and review by improving communications among the plan, it's developers, and it's users.
b. An improved graphic representation of a project for better communication due to the improved computer generated display of the project and its tasks. All project personnel, from the task responsibility to top management can view and discuss TSCPM and Bar Charts best when those charts contain CNs, knowing that they have a common understanding of the project and creating an improved project team among corporate management levels.

3. Having thus disclosed my invention I claim that computer generated Time Scaled Critical Path Method or Bar Chart precedence network diagrams with Column Nodes improve management fundamentals, wherein the improvement comprises:
a. An improved graphic representation of a project which better illustrates goals or objectives and encourages Management by Objectives.
b. An improved graphic representation of a project which permits faster review and update and encourages increased management Span of Control.
c. An improved graphic representation of a project for better coordination due to the clear display of tasks to be accomplished and their relationship to one another. It better establishes to each Task Manager the scope of his tasks, when they may be scheduled to start, when they should be completed, and what other tasks are dependant on his task's performance. During the planning phase and updates of projects, the Task Managers, responsible for performance and completion of tasks, can easily see how any failure on their part can adversely impact their fellow project team members, or the project itself, and how all involved can resolve problems in the best interests of the project.
d. An improved graphic representation of a project for better control due to the improved computer generated display of tasks/responsibilities and their relationship in the project. The task responsibility, the project manager, and top management can all observe problems and find corrections mutually due to all understanding the information displayed. This problem solving is done involving the project manager who can replan to incorporate changes, and when necessary, involve top management who can assign necessary resources.
e. An improved graphic representation of a project for better commitment due to the improved computer generated display of tasks and their impact on other tasks in a project. Every Task Manager responsible for performing a task becomes aware that his task has impact on other tasks and the project as a whole. This very visible information tends to encourage the Task Manager to maintain his part of the scheduled plan.
